(19) United States
(12) Patent Application Publication
(10) Pub. No.: US 2007/0159525 A1
(43) Pub. Date: Jul. 12, 2007

(54) Stereoscopic display apparatus and stereoscopic display method

(76) Inventors: Isao Tomisawa, Saitama (JP); Masaru Ishikawa, Saitama (JP)

Correspondence Address: DRINKER BIDDLE & REATH (DC), 1500 K STREET, N.W., SUITE 1100, WASHINGTON, DC, 20005-1209, US

(21) Appl. No.: 10/592,324

(22) PCT Filed: Mar. 11, 2005
(86) PCT No.: PCT/JP05/04845

§ 371 Date: Sep. 11, 2006

(30) Foreign Application Priority Data
Mar. 12, 2004 (JP) 2004-071107

(51) Int. Cl. H04N 13/04; G02B 27/22; H04N 15/00

(52) U.S. Cl. 348/51; 359/462

(57) ABSTRACT

An object of the invention is to obtain a stereoscopic display apparatus which makes it possible to alleviate a viewer's fatigue and allow a stereoscopic two-dimensional image to be recognized more naturally, thereby improving the sense of realism, visibility, and amusement features.

In the invention, an image display unit 21 is constituted by a display portion 27 having an image display surface for displaying a two-dimensional image and an image transmission panel 29 disposed in spaced-apart relation to the image display surface 31a and adapted to allow the light emergent from the image display surface 31a to form an image so as to display a two-dimensional image stereoscopically. A plurality of image display units 21 and 21 are installed such that the image transmission panels 29 form the predetermined angle α with respect to each other. A first image, which is one image of an object viewed from two different directions, is displayed on one 21a of the adjacent image display units 21 and 21, while a second image, which is another image of a display object, i.e., the object, viewed from the two different directions, is displayed on another one 21b of the adjacent image display units 21 and 21.

### TECHNICAL FIELD

The present invention relates to a stereoscopic display apparatus for displaying a two-dimensional image stereoscopically and a stereoscopic display method.

### BACKGROUND ART

In recent years, with respect to interior design appliances, displays for sales promotion, communication terminal devices, game apparatuses, and the like, attempts have been made to stereoscopically reproduce image information by various methods for the purpose of improving the sense of realism, visibility, and amusement features. Generally, binocular parallax (a difference in visual directions or a disparity in retinal images between both eyes occurring when a solid or an object of a different depth is viewed with both eyes) is one physiological factor allowing a human being to view an object stereoscopically. As a method of reproducing a stereoscopic image on the basis of this binocular parallax, a polarization method is known in which a viewer wears polarized glasses and views left and right disparity images based on mutually different polarized states. However, the wearing of the polarized glasses constitutes a troublesome drawback to the viewer.

In contrast, as a method of displaying a stereoscopic image which does not use polarized glasses, a lenticular lens method is known. This is a technique in which a plurality of screens are formed as latent images on one screen, the plurality of screens are viewed through a translucent screen in which semicylindrical lenses of fixed widths are connected in the horizontal direction, so as to enable stereoscopic representation or representation of moving images. Namely, images which are obtained by dividing each of the plurality of images into stripes in the vertical direction in correspondence with the pitches of the semicylindrical lenses are arrayed regularly, and stereoscopic vision is realized on the basis of the focal position of each lens which changes due to the direction in which the screen is viewed and the distance and on the basis of how the image disposed there is viewed. Specifically, for the reproduction of a stereoscopic image, alternately arrayed stripe images are supplied to both eyes of the viewer from two left and right disparity images corresponding to both eyes of the viewer by using the lenticular lenses, so as to allow a stereoscopic image to be recognized.

### Patent Document 1: JP-A-10-221644

In the above-described lenticular lens method, since the two disparity images are each divided into one pixel row and are alternately combined to synthesize one image, and light rays from one set of disparity images are respectively focused in the directions toward the viewer's right eye and left eye by using the lenticular lens, the resolution in the lateral direction of the stereoscopic image is reduced to one half with respect to one original image. In addition, the design of the lenticular lens and the operation of accurately combining the lens and the image are required.

To overcome such a drawback, an image display apparatus has been proposed for displaying a stereoscopic two-dimensional image with a simple construction by allowing a two-dimensional image to be formed as a real image by microlens arrays. As shown in FIG. 1, this image display apparatus 1 consists of a display unit 3 for displaying on a planar image display surface 3a a two-dimensional image including a stereoscopic image, as well as an image transmission panel 11 which is disposed in parallel to and spaced apart from the image display surface 3a and includes a microlens array 5 formed by a plurality of lenses and having a wider effective area than a stereoscopic image in the two-dimensional image and a lens frame area 7 surrounding an effective region of the microlens array 5. The image transmission panel 11 is adapted to generate an image forming plane 9 of a real image P of a two-dimensional image in a space located on a side opposite to the display unit 3. According to this image display apparatus 1, it is possible to stereoscopically display a two-dimensional image including a stereoscopic image with a very simple construction. In addition, polarized glasses is not required, and the resolution of the stereoscopic image is not caused to decline.

However, although the above-described image display apparatus 1 is capable of easily displaying a two-dimensional image stereoscopically, the image display apparatus 1 does not make use of binocular parallax which, generally, is a principal physiological factor allowing a human being to view an object stereoscopically. In addition, in the lenticular lens method, despite the fact that the foci of the eyes are constantly focused on the disparity images, the image is perceived as being at a different position from it (namely, a real image is not being viewed), so that disagreement occurs between focal accommodation and convergence, and the viewer's fatigue increased accompanied by physiological unnaturalness. It should be noted that the convergence referred to herein means a physiological factor whereby the depth is perceived on the basis of the fact that when eyeballs of both eyes are rotated inward to cause an image of the object to come to the centers of the retinas, the intersection angle (convergence angle) of the optical axes differs depending on the distance to the object. Consequently, with the conventional image display apparatus, the rendering power for visually perceiving the difference in depth has been insufficient, so that there has been a limit to the more natural display of stereoscopic two-dimensional images, and it has been impossible to obtain sufficient sense of realism, visibility, and amusement features.

### DISCLOSURE OF THE INVENTION

The invention has been devised in view of the above-described circumstances, and its object is to provide a stereoscopic display apparatus which makes it possible to alleviate the viewer's fatigue and allow a stereoscopic two-dimensional image to be recognized more naturally, thereby improving the sense of realism, visibility, and amusement features.

A stereoscopic display apparatus in accordance with the invention for attaining the above object is characterized in that: an image display unit is constituted by a display portion having an image display surface for displaying a two-dimensional image and an image transmission panel disposed in spaced-apart relation to the image display surface and adapted to allow the light emergent from the image display surface to form an image so as to display a stereoscopic two-dimensional image in a space located on an opposite side to the display portion; at least two of the image display units are provided; a first image which is one image of a display object viewed from two different directions is displayed on the display portion of one of the image display units; and a second image which is another image of the display object viewed from the two different directions is displayed on the display portion of another one of the image display units.

### BRIEF DESCRIPTION OF THE DRAWINGS

FIG. 1 is a perspective view illustrating a schematic configuration of a conventional image display apparatus;

FIG. 2 is a schematic diagram illustrating a first embodiment of a stereoscopic display apparatus in accordance with the invention;

FIG. 3 is a cross-sectional view of an image display unit shown in FIG. 2;

FIG. 4 is a partial cross-sectional view of a microlens array shown in FIG. 3;

FIG. 5 is a diagram explaining the operation of the stereoscopic display apparatus shown in FIG. 1;

FIG. 6 is a schematic diagram illustrating a second embodiment of a stereoscopic display apparatus in accordance with the invention;

FIG. 7 is a schematic diagram illustrating a third embodiment of a stereoscopic display apparatus in accordance with the invention;

FIG. 8 is a schematic diagram illustrating a fourth embodiment of a stereoscopic display apparatus in accordance with the invention; and

FIG. 9 is a schematic diagram of a modification of the fourth embodiment.

It should be noted that, in the drawings, reference numerals 21, 22, 24, 25, and 26 denote image display units; 21b and 22b, other ones of the adjacent image display units; 21a and 22a, ones of the adjacent image display units; 27, a display portion; 28, one display portion; 29, image transmission panel; 31a, an image display surface; 43, a microlens array; 50, an angle-of-view restricting filter; 53, an image forming plane; 61, a left view point image (one image); 63, a right view point image (other image); 65, a display object which is recognized by a viewer; 71, a nondisplay region; 100, 200, and 300, stereoscopic display apparatuses; and α, a predetermined angle.

### BEST MODE FOR CARRYING OUT THE INVENTION

Referring now to the drawings, a description will be given of the preferred embodiments of the stereoscopic display apparatus and a stereoscopic display method in accordance with the invention.

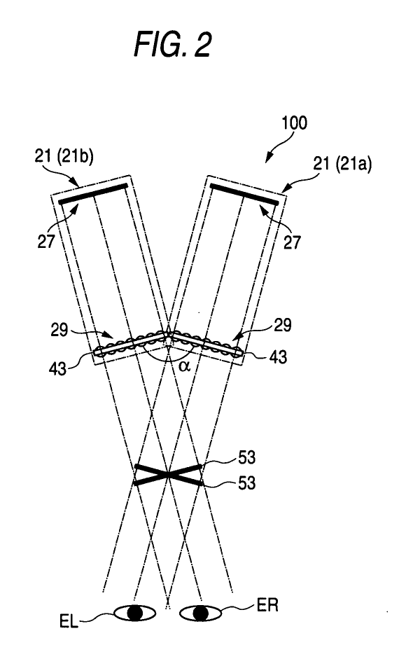

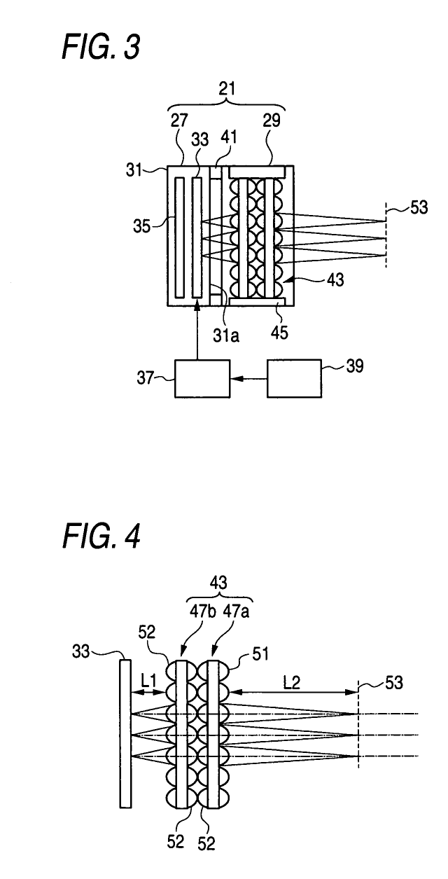

FIG. 2 is a schematic diagram illustrating a first embodiment of the stereoscopic display apparatus in accordance with the invention. FIG. 3 is a cross-sectional view of the image display apparatus shown in FIG. 2.

A stereoscopic display apparatus 100 in accordance with this embodiment has a plurality of image display units 21(a) and 21(b) installed therein. As shown in FIG. 3, the image display unit 21, if largely classified, consists of a display portion 27 and an image transmission panel 29. The display portion 27 has, for instance, a color liquid-crystal display (LCD) 31 as a principal member. (See FIG. 3.)

In FIG. 3, the LCD 31 has a planar image display surface 31a for displaying a two-dimensional image including a stereoscopic image. The LCD 31 is provided with a flat color liquid-crystal panel 33 of the image display surface 31a, a backlight illuminating portion 35, and a color liquid-crystal drive circuit 37. The color liquid-crystal drive circuit 37 is connected to a video signal supplying unit 39 for supplying a video signal for the two-dimensional image including a stereoscopic image. It should be noted that, as the display portion 27, a cathode-ray tube, a plasma display, an organic electroluminescence display, or the like may be used instead of the LCD 31.

A support member 41 is fixed to peripheral edges of the LCD 31, and the support member 41 supports the image transmission panel 29. The image transmission panel 29 consists of a microlens array 43, as well as a lens frame 45 surrounding an effective region of the microlens array 43. The support member 41 supports the lens frame 45, and disposes the image transmission panel 29 in parallel to and spaced apart from the image display surface 31a of the color liquid-crystal panel 33. It should be noted that the image transmission panel 29 and the image display surface 31a of the color liquid-crystal panel 33 need not necessarily be disposed in parallel to each other.

The effective area of the microlens array 43 is set to be identical to or larger than the area of the image display surface 31a of the color liquid-crystal panel 33. The lens frame 45 has a dark color such as black, and suppresses the degree by which the viewer becomes conscious of the presence of the microlens array 43.

FIG. 4 is a partial cross-sectional view of the microlens array shown in FIG. 3.

The microlens array 43 is composed of a plurality of microlenses arranged two-dimensionally. The microlens array 43 is a convex microlens plate formed by integrating two lens array halves 47a and 47b as a set. In the convex microlens plate, a plurality of lens systems each consisting of a pair of convex lenses with their optical axes arranged coaxially are arranged two-dimensionally so that their optical axes become parallel to each other.

The distance L2 between the lens surface and an image forming plane 53 of the right lens array half 47a in FIG. 4 is approximately equal to the distance L1 between the lens surface and the color liquid-crystal panel 33 of the left lens array half 47b in the drawing, or the distance L2 can be made longer than the distance L1 depending on the construction of the microlens array (e.g., by combining lenses of different curvatures). Consequently, the image forming plane 53 is sufficiently spaced apart from the image transmission panel 29, and the depth of the image display unit 21 can be made compact.

When the microlens array 43 is disposed at a position spaced apart the working distance L1 of a substantially convex lens 52 with respect to the front surface of the display portion 27, the microlens array 43 projects the image displayed on the display portion 27 onto the image forming plane 53 spaced part the focal length L2 on the opposite side to the display portion 27. Although this projected image is a two-dimensional image, in a case where the image is one which has depth (stereoscopic), the image is displayed as if it is floating in the space. Therefore, it appears to the viewer as if a stereoscopic image is being displayed. Hereafter, in this description, the two-dimensional image displayed on the image forming plane 53 will be referred to as a stereoscopic two-dimensional image.

It should be noted that the two-dimensional image displayed on the display portion 27 is vertically inverted when it passes through one lens array half 47b, but the two-dimensional image is inverted again when it passes through the other lens array half 47a. As a result, the image transmission panel 29 is capable of displaying the two-dimensional image displayed on the display portion 27 as an erect stereoscopic two-dimensional image on the image forming plane 53.

In addition, although in the above-described embodiment the microlens array 43 is integrated by the two lens array halves 47a and 47b as a set, this construction may not necessarily be adopted. For example, a single microlens array half can be formed by a single piece or three pieces. However, in a case where the image which is formed by each of the lenses forming the microlens array is displayed by being inverted, it is necessary to construct the microlens array such that one lens is allotted to one display pixel of the display portion 27.

Thus, in the stereoscopic display apparatus 100, the image display unit is comprised of the display portion 27 having the image display surface 31a for displaying an image and the image transmission panel 29 which is disposed in spaced-apart relation to the image display surface 31a with respect to the light emergent from the image display surface 31a, and which displays a two-dimensional image stereoscopically by forming an image of the light emergent from the image display surface 31a. The two image display units 21 and 21 are installed such that the image transmission panels 29 or extension lines of the image transmission panels 29 mutually form a predetermined angle α which is smaller than 180 degrees. The image transmission panel and the microlens array need not necessarily be disposed in contact with each other. In the image display units 21 and 21, different video signals are supplied from the respective video signal supplying units 39 to the respective color liquid-crystal drive circuits 37. It should be noted that a plurality of stereoscopic display apparatuses 100 may be installed, and a control unit for controlling them may be provided.

Here, as principal factors inducing the stereoscopic sense, it is possible to cite binocular parallax, focal accommodation, convergence, and motion parallax, and binocular parallax among them constitutes the most important factor in the depth perception in the near distance. Accordingly, in the stereoscopic display apparatus 100,

Video signals for a first image and a second image are adapted to be supplied from the video signal supplying units 39 to the respective color liquid-crystal drive circuits 37, such that a first image (left view point image), which is one image of a display object viewed from two different directions, is displayed on the display portion 27 of one 21a of the adjacent image display units 21 and 21, while a second image (right view point image), which is the other image of the display object viewed from the two different directions, is displayed on the display portion 27 of the other one 21b of the adjacent image display units 21 and 21.

Next, a description will be given of the operation of the above-described stereoscopic display apparatus on the basis of the image display method.

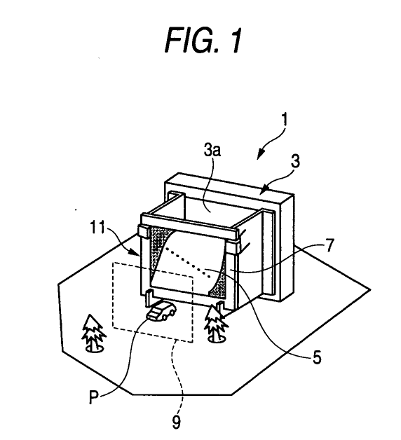

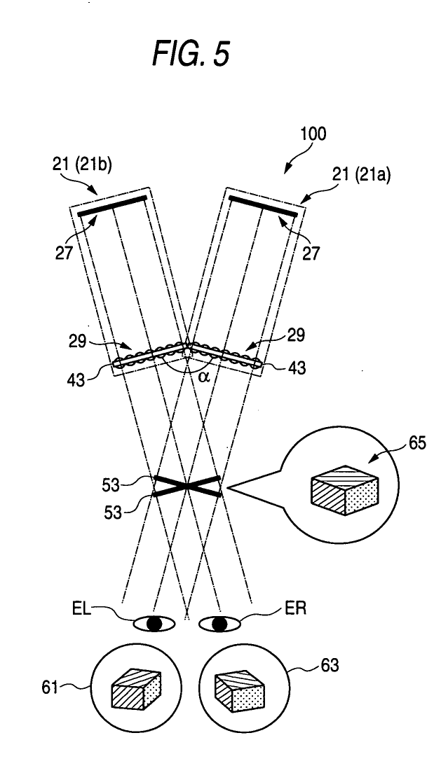

FIG. 5 is a diagram explaining the operation of the stereoscopic display apparatus shown in FIG. 1.

In the stereoscopic display apparatus 100, a left view point image 61 and a right view point image 63 are formed on the image forming planes 53 and 53 as stereoscopic two-dimensional images by the respective image display units 21 and 21. Accordingly, as the first image (left view point image 61) viewed from the left side of a display object 65 and the second image (right view point image 63) viewed from the right side thereof are respectively shown to the viewer's left eye EL and right eye ER, and processing is carried out in the viewer's brain, thereby allowing one image having a sense of depth to be synthesized. At this juncture, in the stereoscopic display apparatus 100 in accordance with this embodiment, the respective left view point image 61 and right view point image 63 are viewed as stereoscopic two-dimensional images formed on the image forming planes 53.

Therefore, according to this stereoscopic display apparatus 100, the plurality of image display units 21 and 21 are installed such that the image transmission panels 29 mutually form the predetermined angle α, and one image (left view point image 61) of the display object 65 viewed from two different directions is displayed on the one 21a of the adjacent image display units 21 and 21, while the other image (right view point image 63) of the display object 65 viewed from the two different directions is displayed on the other one 21b of the adjacent image display units 21 and 21. Hence, two different images viewed from the different directions are formed on the image forming planes 53 as stereoscopic real images, and the respective left and right eyes capture different stereoscopic two-dimensional images. Accordingly, the disagreement between focal accommodation and convergence is decreased, and stereoscopic images which are natural and difficult to fatigue can be displayed in comparison with the method in which the light is focused in directions toward the right eye and the left eye from parallax images by using the conventional lenticular lenses. It should be noted that since the left view point image 61 and the right view point image 63, which are the stereoscopic two-dimensional images, respectively have narrow angles of view, the left view point image 61 and the right viewpoint image 63 can be recognized properly by the viewer's left eye and right eye, respectively, so that the stereoscopic two-dimensional images can be recognized more naturally. As a result, it is possible to alleviate the viewer's fatigue and allow stereoscopic two-dimensional images to be recognized more naturally by making use of binocular parallax, thereby improving the sense of realism, visibility, and amusement features.

Next, a description will be given of a second embodiment of the stereoscopic display apparatus in accordance with the invention.

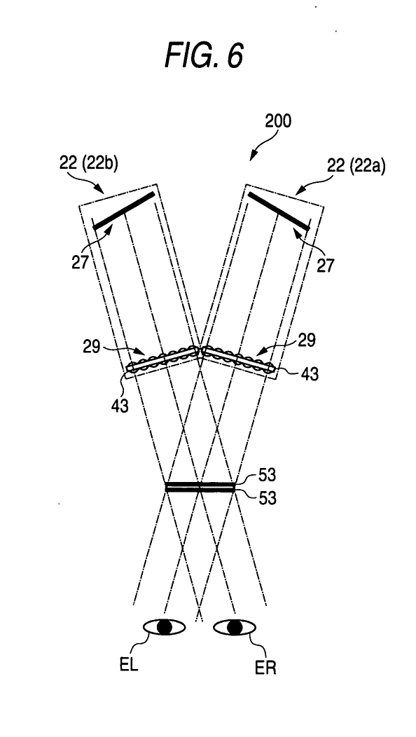

FIG. 6 is a schematic diagram of the second embodiment of the stereoscopic display apparatus in accordance with the invention.

In a stereoscopic display apparatus 200 in accordance with this embodiment, the display portion 27 and the image transmission panel 29 of each of a pair of adjacent image display units 22 and 22 are disposed in nonparallel such that the image forming plane 53 of one image display unit 22a of a pair of adjacent image display units 22 and 22 and the image forming plane 53 of the other image display unit 22b thereof are set in an identical plane (or in proximate parallel planes. The other arrangements are identical to those of the above-described stereoscopic display apparatus 100.

Therefore, according to this stereoscopic display apparatus 200, since the display portion 27 and the image transmission panel 29 of each of the pair of adjacent image display units 22 and 22 are disposed in nonparallel such that the image forming plane 53 of the one image display unit 22a of the pair of adjacent image display units 22 and 22 and the image forming plane 53 of the other image display unit 22b thereof are set in the identical plane, two different two-dimensional images which a reviewed from different directions are formed obliquely. In consequence, stereoscopic real images can be disposed in an overlapping manner in the identical plane, so that a set of disparity mages constituted by real images can be formed with high resolution.

Next, a description will be given of a third embodiment of the stereoscopic display apparatus in accordance with the invention.

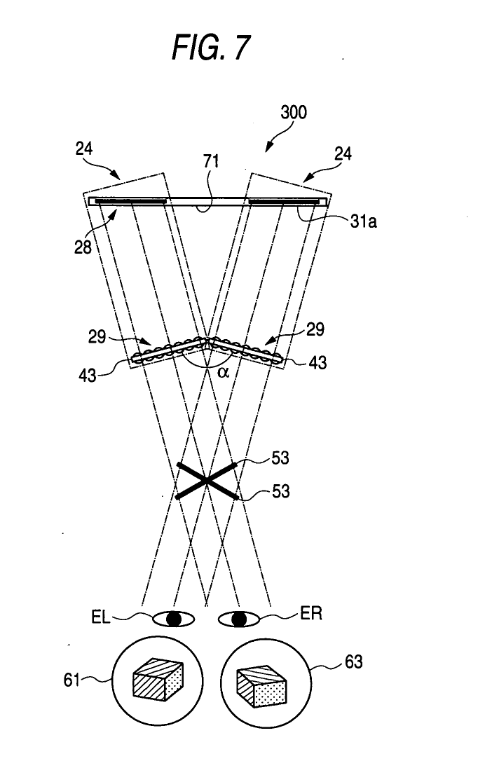

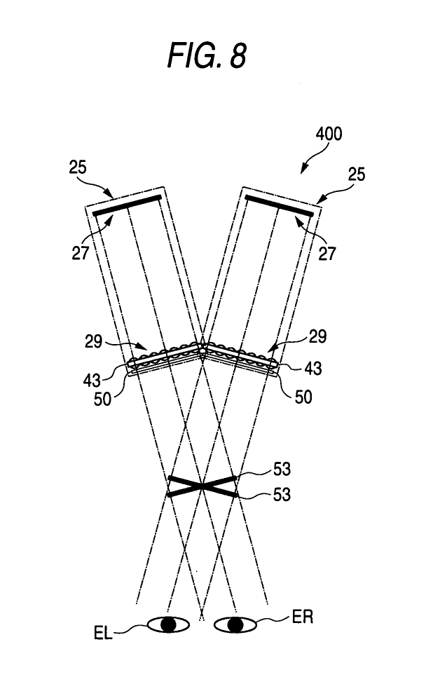

FIG. 7 is a schematic diagram of the third embodiment of the stereoscopic display apparatus in accordance with the invention.

In a stereoscopic display apparatus 300 in accordance with this embodiment, a pair of adjacent image display units 24 and 24 are constructed by sharing one display portion 28 having the image display surfaces 31a in an identical plane, and the image transmission panels 29 and 29 or their extension lines mutually form the predetermined angle α. In addition, a nondisplay region 71 is provided in a central portion between the image display surfaces 31a in the display portion 28. One image (left view point image 61) of the display object viewed from two different directions is displayed in one display region of the image display surfaces 31a with this nondisplay region 71 located therebetween, while the other image (right view point image 63) of the display object viewed from the two different directions is displayed in the other display region of the image display surfaces 31a with this nondisplay region 71 located therebetween.

Accordingly, according to this stereoscopic display apparatus 300, since the pair of adjacent image display units 24 and 24 are constructed by sharing one display portion 28 having the image display surfaces 31a in an identical plane, and the image transmission panels 29 and 29 or their extension lines mutually form the predetermined angle α, the display portion 28 as well as the color liquid-crystal drive circuit 37 and the video signal supplying unit 39 for causing this display portion 28 to effect image display can be made singular, so that the cost of the apparatus can be made inexpensive.

In addition, since the display function of the display nonrequiring region 71 in the display portion 28 which is made singular is omitted, the manufacturing cost of the singularly formed display portion 28 can be made further inexpensive.

Next, a description will be given of a fourth embodiment of the stereoscopic display apparatus in accordance with the invention.

FIG. 7 is a schematic diagram of the fourth embodiment of the stereoscopic display apparatus in accordance with the invention.

In a stereoscopic display apparatus 400 in accordance with this embodiment, an angle-of-view restricting filter 50, which is angle-of-view restricting means, is disposed in front of (on the image forming plane 53 side) of the image transmission panel 29 of each of a pair of adjacent image display units 25 and 26. The other arrangements are identical to those of the stereoscopic display apparatus 100.

The angle-of-view restricting filter 50 is for restricting the light from unnecessary angles so that the right view point image does not enter the left eye EL, and the left view point image does not enter the right eye.

There has been a possibility that the right view point image and the left view point image respectively enter the left eye EL and the right eye ER; however, by virtue of the provision of the angle-of-view restricting filter 50, it is possible to prevent it, and it becomes possible for the viewer to visually perceive a stereoscopic two-dimensional image clearly.

It should be noted that, as the angle-of-view restricting means, it is possible to use a filter, a slit, a diaphragm, or the like for restricting the angle of view.

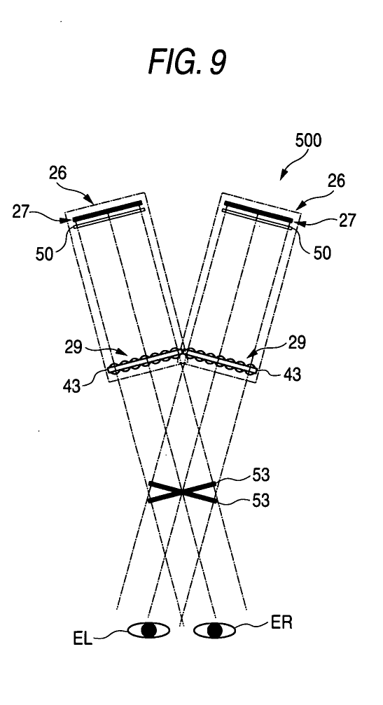

In addition, FIG. 9 is a schematic diagram of a modification of the fourth embodiment.

In a stereoscopic display apparatus 500 in accordance with this modification, the angle-of-view restricting filter 50, i.e., the angle-of-view restricting means, is provided in front of (on the image transmission panel 29 side) the display portion 27 in each of a pair of adjacent image display units 26 and 26.

This stereoscopic display apparatus 500 exhibits operational effects similar to those of the above-described stereoscopic display apparatus 400.

This application is based on Japanese Patent Application filed on Mar. 12, 2004 (Japanese Patent Application No. 2004-71107), the contents of which are incorporated herein by reference.

1. A stereoscopic display apparatus characterized in that:
an image display unit is constituted by a display portion having an image display surface for displaying a two-dimensional image and an image transmission panel disposed in spaced-apart relation to the image display surface and adapted to allow the light emergent from the image display surface to form an image so as to display a stereoscopic two-dimensional image in a space located on an opposite side to the display portion;
at least two of the image display units are provided;
a first image which is one image of a display object viewed from two different directions is displayed on the display portion of one of the image display units; and
a second image which is another image of the display object viewed from the two different directions is displayed on the display portion of another one of the image display units.

2. The stereoscopic display apparatus according to claim 1, wherein the image transmission panel is constituted by a microlens array.

3. The stereoscopic display apparatus according to claim 1 or 2, wherein the first image is a right viewpoint image, and the second image is a left view point image.

4. The stereoscopic display apparatus according to any one of claims 1 to 3, wherein the image transmission panels are disposed so as to form a predetermined angle with respect to each other.

5. The stereoscopic display apparatus according to any one of claims 1 to 4, wherein an image forming plane based on the one image display unit and an image forming plane based on the other image display unit overlap.

6. The stereoscopic display apparatus according to any one of claims 1 to 5, wherein an image forming plane based on the one image display unit and an image forming plane based on the other image display unit are formed in a substantially identical plane.

7. The stereoscopic display apparatus according to any one of claims 1 to 6, wherein the at least two image display units share the display portion.

8. The stereoscopic display apparatus according to any one of claims 1 to 7, wherein at least one of the display portion and the image transmission panel has angle-of-view restricting means for restricting an angle of view.

9. A stereoscopic display method characterized in that:
installing at least two image display units each constituted by a display portion having an image display surface for displaying a two-dimensional image and an image transmission panel disposed in spaced-apart relation to the image display surface and adapted to allow the light emergent from the image display surface to form an image so as to display a stereoscopic two-dimensional image in a space located on an opposite side to the display portion;
displaying on the display portion of one of the image display units a first image which is one image of a display object viewed from two different directions;
displaying on the display portion of another one of the image display units a second image which is another image of the display object viewed from the two different directions.
